(19) United States
(12) Patent Application Publication
(10) Pub. No.: US 2004/0082494 A1
(43) Pub. Date: Apr. 29, 2004

(54) Use of amphilic block copolymers in order to increase the water affinity of low-energy surfaces

(76) Inventors: Lionel Queval, Salaise-Sur-Sanne (FR); C?eacute;cile Bonnet-Gonnet, Paris (FR); Mathias Destarac, Paris (FR)

Correspondence Address: BURNS DOANE SWECKER & MATHIS L L P, POST OFFICE BOX 1404, ALEXANDRIA, VA, 22313-1404, US

(21) Appl. No.: 10/468,478

(22) PCT Filed: Feb. 18, 2002
(86) PCT No.: PCT/FR02/00616

(51) Int. Cl. C11D 3/37

(52) U.S. Cl. 510/475

(57) ABSTRACT

The invention relates to the use of an amphilic block copolymer, comprising at least one hydrophic bloc and at least one hydrophobic block, in order to create a low-energy surface such as a plastic or thermoplastic polymer based surface, a deposit increasing the affinity of said surface with regard to water. Said deposit can be used to increase the efficiency of a filmogenic, aqueous composition which is later applied to the surface thus modified. The invention also relates to a method for applying paint or mastic compositions on a low-energy surface, highlighting the use thereof, in addition to coated plastic or thermoplastic type materials which can be obtained according to said application method.

The present invention relates to the use of an amphiphilic block copolymer, comprising at least one hydrophilic block and at least one hydrophobic block, for producing, over a low-energy surface, such as a surface based on a plastic or thermoplastic polymer, a deposited layer which increases the affinity of said surface with respect to water, it being possible for this deposited layer to be used in particular for increasing the effectiveness of the subsequent application of an aqueous film-forming composition to the surface thus modified.

The invention also relates to a process for the application of paint or mastic compositions to a low-energy surface which takes advantage of this type of use and to the materials of coated plastic or thermoplastic polymer type capable of being obtained according to such an application process.

The term “low-energy surface” within the meaning of the invention is to be understood as materials exhibiting a low affinity for water which is reflected by a low, indeed even zero, wettability. This wettability is evaluated by the measurement of the contact angle of a drop of water deposited on the surface of the material. This contact angle, generally known as a angle, corresponds to the angle which exists between the surface and the tangent to the drop at the surface/water/air interface and can be measured particular using a conventional contact angle measuring device, such as, for example, the SDT-200 sold by IT Concept, used in static mode.

The sheets must be perfectly clean, that is to say rubbed beforehand with ethanol. Furthermore, they are reconditioned, that is to say maintained for 24 hours in a climate-controlled chamber under specific temperature and humidity conditions (22° C., 55% relative humidity).

This angle can be between 0 and 180°.

If the angle is zero, then the wetting is 100%. The liquid spreads completely over the surface and there therefore exists strong interactions between the support and the liquid.

If the angle is 180°, then the wetting is zero. The liquid forms a bead. There is only one point of contact between the liquid and the support and in particular no affinity.

For intermediate angles, the wetting is partial.

Thus, it is considered that, when this contact angle is greater than 45°, then the material has a low-energy surface.

Generally, low-energy materials have a hydrophobic nature. The term “surface of “hydrophobic” nature” within the meaning of the invention is to be understood as a surface characterized by a contact angle of a drop of water of greater than or equal to 45° and generally of greater than 70°. The term “hydrophilic” is, for its part, employed to denote a surface characterized by a contact angle of a drop of water of less than 45°, preferably of less than or equal to 30°.

Mention may be made, as example of materials having a low-energy surface, of plastic or thermoplastic polymers, such as polyamides, polycarbonates, poly(ethylene terephthalate)s, poly(methyl methacrylate), polypropylenes, polyethylenes, polystyrenes, polyesters, acrylonitrile-butadiene-styrene (ABS) or poly(vinyl chloride)s.

The values measured for the a angle for these materials are combined, by way of illustration, in table I of example 4.

Thus, when an aqueous film-forming composition of paint type or mastic type which may or may not comprise silicone is applied directly to the surface of one of these materials, very poor wetting of the surface by the aqueous composition is observed, which renders impossible the application of this composition or else results, in the best cases, in the production of a coating of mediocre quality.

Furthermore, the adhesive properties of the coatings thus obtained deteriorate in the presence of moisture or on contact of these surfaces with water, in particular because of phenomena of diffusion of water to the interface.

For all these reasons, the deposition of an aqueous film-forming composition of paint type or mastic type which may or may not comprise silicone on a support with a low surface energy, of plastic or thermoplastic polymer type, generally cannot be envisaged industrially.

Now, the Applicant has discovered that certain amphiphilic block copolymers can be used to produce, on low-energy surfaces, deposited layers which generally exhibit a strong affinity with respect to these surfaces and which modify the properties thereof, in particular by increasing their wettability and/or by conferring a hydrophilic nature thereon.

The modifications induced by the presence of a deposited layer based on these block polymers make it possible to alleviate the problems encountered to date and it is possible to obtain an improvement in the effectiveness of the application of an aqueous film-forming composition of paint or mastic type but also an improvement in the adhesion to the support of this aqueous film-forming composition which is effective and lasting, even in the presence of water.

This improvement in the adhesion of the coating is reflected by a prolonged decorative, protective or functional effect, advantageously throughout the lifetime of the product, without the effect induced by the coating produced being capable of being threatened by washing with an aqueous solution (S) with a pH of between 1 and 12, optionally comprising sodium chloride, in a proportion of a maximum concentration of 10 M, peeling or disintegration of the said coating, in particular under the effect of mechanical stresses.

More generally, the deposited layer based on the block copolymers of the invention generally has an affinity with respect to the low-energy surface such that this deposited layer remains firmly attached to the treated surface for relative humidities ranging from 0 to 100%. Advantageously, the deposited layer remains firmly attached in the presence of water, indeed even under immersion in water, including on surfaces of very low energy and/or which are strongly hydrophobic, such as, for example, surfaces based on polypropylene or a polyethylene.

Due to the modification in the surface properties which they bring about, and taking into account their behavior toward water, deposited layers based on the block copolymers produced according to the invention can be employed in numerous fields of application.

Thus, according to a first aspect, a subject matter of the present invention is the use of an amphiphilic block copolymer comprising at least one block of hydrophobic (H) nature and at least one block of hydrophilic (h) nature, the block of hydrophobic nature exhibiting hydrophilic units in an amount of 0% and 95% by weight and preferably between 0.1 and 90% by weight with respect to the total weight of the units of the hydrophobic block, said copolymer optionally being dissolved in a solvent, such as an organic solvent, water or a water/alcohol mixture, to produce, on a low-energy surface, a deposited layer which increases the affinity of said surface with respect to water.

The term “increase in the affinity of a low-energy surface with respect to water” is understood to mean an increase in the wettability of said surface by water and aqueous solutions. This increase in the affinity for water is usually accompanied, more generally, by an increase in the wettability by polar solvents other than water, such as glycerol.

This increase in the wettability subsequent to the deposition of the amphiphilic block copolymer of the invention is demonstrated by measuring, under the same temperature and relative humidity conditions, the contact angle presented by a drop of water deposited on the surface, before and after the deposition of said copolymer.

The increase in the wettability of the surface observed subsequent to the deposition of the block copolymer on the surface is reflected by a decrease in the contact angle measured in comparison with the angle measured before the deposition. The decrease observed can vary to a fairly large extent depending on the exact nature of the low-energy surface on which the deposition of the block copolymer is carried out.

However, generally, the closer the contact angle initially measured is to 180°, the greater the likelihood of the decrease in the contact angle obtained subsequent to the deposition of the copolymer being high.

Thus, under relative humidity conditions from at 0 to 100% and at temperatures of 15 to 35° C., the deposition of a block copolymer according to the invention makes it possible, for example, for a surface of methacrylate type, to pass from a contact angle of 72° to an angle of less than 62°.

The amphiphilic block copolymer of the invention can advantageously be employed to confer a hydrophilic nature on a surface initially exhibiting a hydrophobic nature, such as, for example, certain surfaces based on plastic or thermoplastic polymers.

Thus, the invention also relates to the use of an amphiphilic block copolymer comprising at least one block of hydrophobic nature (H) and at least one block of hydrophilic nature (h), the block of hydrophobic nature exhibiting hydrophilic units in an amount of between 0% and 95% by weight with respect to the total weight of the units of the hydrophobic block, said copolymer optionally being dissolved in a solvent, such as an organic solvent, water or a water/alcohol mixture, to render a surface possessing a hydrophobic nature compatible with its environment possessing a hydrophilic nature.

Such deposited layers can, for example, be applied to polyamide fibers intended to be used as reinforcing fillers in asbestos cement compositions and therefore can render these fibers, originally hydrophobic, compatible in a hydrophilic medium. These deposited layers can also be applied to fibers of polyester or polyamide type, in order to produce fabrics exhibiting an increased suitability for washing.

A particularly advantageous aspect of the invention relates to the use of an amphiphilic block copolymer comprising at least one block of hydrophobic nature (H) and at least one block of hydrophilic nature (h), the block of hydrophobic nature exhibiting hydrophilic units in an amount of between 0% and 95% by weight and preferably 0.1 and 90% by weight with respect, to the total weight of the units of the hydrophobic block, said copolymer optionally being dissolved in a solvent, such as an organic solvent, water or a water/alcohol mixture, to produce, on a low-energy surface, a deposited layer which renders effective and lasting a subsequent application of a composition (F) to said low-energy surface.

The invention thus relates to a process for the application of an aqueous film-forming composition (F) to a low-energy surface, comprising the following stages:

(A) a formulation optionally comprising a solvent, such as an organic solvent, water or a water/alcohol mixture, comprising an amphiphilic block copolymer comprising at least one block of hydrophobic nature and at least one block of hydrophilic nature, the block of hydrophobic nature exhibiting hydrophilic units in an amount of between 0% and 95% by weight with respect to the total weight of the units of the hydrophobic block, is applied to said surface, so as to form, on said surface, a deposited layer in the form of a continuous coat; and

(B) the solvent is at least partially removed from the deposited layer obtained in stage (A); and

(C) said aqueous film-forming composition (F) is applied to the surface, thus modified, obtained in stage (B).

The deposited layer based on the block copolymer produced according to the invention can be prepared by applying, to the low-energy surface, a solution comprising said block copolymer or by immersing the surface to be treated in a solution based on the block copolymer, and by then subsequently removing, at least partially and preferably largely, the solvent initially present in this solution, for example by drying.

The term “partial removal” is to be understood as meaning the removal of at least 70% by mass of the solvent initially present, preferably of at least 80% by mass and more advantageously still of at least 90% by mass.

The removal “largely” of the solvent corresponds, for its part, to the removal of at least 95% by mass of the solvent initially present, preferably of at least 97% by mass and more advantageously still of at least 99% by mass.

The solution based on the block copolymer of stage (A) is preferably an aqueous or aqueous/alcoholic solution (for example, in a water/ethanol mixture).

This solution used, whatever the solvent used, has a concentration of block copolymer of, in the most general case, between 0.01 and 10% by mass. In order to obtain optimum wetting of the support and to avoid the appearance of heterogeneities within the deposited layer produced, it is preferable to use a solution at a concentration of between 0.05 and 7% by mass and more preferably still between 0.1 and 3% by mass.

Such contents confer, on the aqueous formulation, a viscosity suitable for application to the low-energy surface. Furthermore, these contents result in the production of a continuous film (without the appearance of dewetting regions) when they are applied using a film drawer to flat surfaces or, more generally, when the surface to be treated is immersed in said solution.

In addition, these concentrations are particularly well suited to carrying out, by simple drying, partial or complete removal of the aqueous or aqueous/alcoholic solvent present in the deposited layer produced in stage (A), which removal is recommended in order to observe an effective improvement in the application of the composition (F) during stage (C).

The drying of stage (B) is carried out, for example, at a temperature of between 15° C. and 50° C. (preferably between 19 and 25° C.) and under humidity conditions of between 10% and 70% and preferably between 50% and 60%.

In the case where the deposited layer of stage (A) is produced using a film drawer, the film obtained has a thickness of between 10 and 100 microns and advantageously between 40 and 60 microns. Thus, the thickness of the film deposited can more advantageously still be of the order of 50 microns.

After the drying of stage (B), a polymer-based deposited layer is obtained which exists in the form of a continuous bonding primer coat with a thickness of between 10 nm and 1 μm, advantageously between 40 and 600 nm and preferably between 50 and 500 nm.

The term “aqueous film-forming composition” within the meaning of the invention is to be understood as any aqueous composition in the form of a dispersion or of a solution, generally in the form of a dispersion where the dispersed phase advantageously exhibits a size of between 10 Å and 100 μm, comprising:

as continuous or solvent phase, water, optionally in combination with other water-soluble compounds, such as alcohols and in particular ethanol; and

compounds of polymer or polymer precursor, acrylic resin or silicone type which are capable of resulting in the formation of a polymer film, of an acrylic film or of a silicone film following the application of the composition to a surface and following the at least partial evaporation of the water and optionally of the other water-soluble compounds, such as ethanol.

Thus, without implied limitation, the aqueous film-forming compositions of the invention can, for example, be compositions comprising an aqueous or aqueous/alcoholic dispersion of carbonaceous polymers in the form of a latex or of a formulation, of adhesive, mastic or paint type, for example, comprising such a latex, or of silicone precursors and in particular a mastic composition of the type of those disclosed in the documents EP 665 862, WO 98/13410 or WO 99/65973.

During the application of the block copolymers of the invention to a hydrophobic surface, these amphiphilic block copolymers, associated as micelles, lamellae or vesicles in water, depending on their microstructure, are adsorbed on the surfaces of hydrophobic nature via the block which has the most affinities with the support (for example, the sodium acrylate block (h) on polyamide and the butyl acrylate block (H) on polypropylene)

This might explain the improvement in the wettability and/or in the increase in the hydrophilic nature which are observed for surfaces of hydrophobic nature treated with the block copolymers of the invention. However, it is apparent that the adhesion results obtained are, surprisingly, much better than those which might have been expected by the use of such molecules as surfactants in the context of such a model.

Thus, the adhesion energies measured for the deposited layers produced based on the block copolymers of the invention are at least 10 times greater, and generally from 50 to 1000 times greater, than the value of the cohesive forces (sum of the Van der Waals forces and the electrostatic repulsion forces) which should theoretically exist between the surface and the block copolymers used.

The block copolymers employed in the preparation of the deposited layer of the invention are preferably such that their hydrophilic block (h) is composed, at least in part, of monomer units selected from:

unsaturated ethylenic mono- and dicarboxylic acids, such as acrylic acid, methacrylic acid, itaconic acid, maleic acid or fumaric acid,

monoalkyl esters of the above unsaturated ethylenic dicarboxylic acids, preferably with C₁-C₄ alcohols, and their N-substituted derivatives, such as, for example, 2-hydroxyethyl acrylate or methacrylate,

amides of unsaturated carboxylic acids, such as acrylamide or methacrylamide, or

ethylenic monomers comprising a ureido group, such as ethylene urea ethyl methacrylamide or ethylene urea ethyl methacrylate, or

ethylenic monomers comprising at least one hydrogen phosphate or phosphonate group, such as vinylphosphonic acid or vinylidenephosphonic acid, or

phosphated acrylates or methacrylates of polyethylene glycol or phosphated acrylates or methacrylates of polypropylene glycol, or

ethylenic monomers comprising a sulfonic acid group or one of its alkali metal or ammonium salts, such as, for example, vinylsulfonic acid, vinylbenzenesulfonic acid, α-acrylamidomethylpropanesulfonic acid or 2-sulfoethylene methacrylate, or

cationic monomers selected from aminoalkyl (meth)acrylates or aminoalkyl(meth)acrylamides; monomers comprising at least one secondary, tertiary or quaternary amine functional group or a heterocyclic group comprising a nitrogen atom, vinylamine or ethyleneimine; diallyldialkylammonium salts; these monomers being taken alone or as mixtures, and in the form of salts, the salts preferably being selected such that the counterion is a halide, such as, for example, a chloride, or a sulfate, a hydrosulfate, an alkyl sulfate (for example comprising 1 to 6 carbon atoms), a phosphate, a citrate, a formate or an acetate, such as dimethylaminoethyl (meth)acrylate, dimethylaminopropyl (meth)acrylate, di(tert-butyl)aminoethyl (meth)acrylate, dimethylaminomethyl(meth)acrylamide or dimethylaminopropyl(meth)acrylamide; ethyleneimine, vinylamine, 2-vinylpyridine or 4-vinylpyridine; trimethylammonium ethyl (meth)acrylate chloride, trimethylammonium ethyl acrylate methyl sulfate, benzyldimethylammonium ethyl (meth)acrylate chloride, 4-benzoylbenzyldimethylammonium ethyl acrylate chloride, trimethylammonium ethyl (meth)acrylamido chloride or (vinylbenzyl)trimethylammonium chloride; diallyldimethylammonium chloride, alone or as mixtures, or their corresponding salts, or

poly(vinyl alcohol), for example resulting from hydrolysis of a poly(vinyl acetate), or

cyclic amides of vinylamine, such as N-vinylpyrrolidone, or

a hydrophilic monomer originating from a chemical modification of a hydrophobic block, for example by hydrolysis of a poly(alkyl acrylate) to poly(acrylic acid).

Preferably, the monomer units present in the hydrophilic block (h) are chosen from acrylic acid (AA), 2-acrylamido-2-methylpropanesulfonic acid (AMPS), styrenesulfonate (SS), monomers comprising ureido group, monomers comprising phosphate or phosphonate group, or their mixtures.

More preferably still, use is made of acrylic acid (AA) units or of ethylenic monomers comprising ureido groups.

The hydrophobic block (H) of the block copolymers employed in the preparation of the deposited layer of the invention is preferably composed, at least in part, of monomer units selected from:

styrene-derived monomers, such as styrene, α-methylstyrene, para-methylstyrene or para-(tert-butyl)styrene, or

esters of acrylic acid or of methacrylic acid with optionally fluorinated C₁-C₁₂, preferably C₁-C₈, alcohols, such as, for example, methyl acrylate, ethyl acrylate, propyl acrylate, n-butyl acrylate, isobutyl acrylate, 2-ethylhexyl acrylate, t-butyl acrylate, methyl methacrylate, ethyl methacrylate, n-butyl methacrylate or isobutyl methacrylate,

vinyl nitriles comprising from 3 to 12 carbon atoms and in particular acrylonitrile or methacrylonitrile,

vinyl esters of carboxylic acids, such as vinyl acetate, vinyl versatate or vinyl propionate,

vinyl halides, for example vinyl chloride, and

diene monomers, for example butadiene or isoprene.

The monomer units present in the hydrophobic block (H) of the block copolymer employed in the preparation of the deposited layer of the invention are preferably esters of acrylic acid with linear or branched C₁-C₈ and in particular C₁-C₄ alcohols, such as, for example, methyl acrylate, ethyl acrylate, propyl acrylate, butyl acrylate or 2-ethylhexyl acrylate, or else styrene derivatives, such as styrene.

This hydrophobic block (H) can additionally comprise between 0 and 95% of hydrophilic monomers selected from the abovementioned list of hydrophilic monomers (h).

The block copolymers according to the invention can advantageously be diblock copolymers composed essentially of the combination of the two (h) and (H) blocks.

The block copolymers of the invention can also be triblock copolymers of formula (h)(H)(h′) or (H) (h) (H′), where (h′) represents a hydrophilic block which may or may not be the same as (h) and where (H′) represents a hydrophobic group which may or may not be the same as (H).

Mention may in particular be made, as block copolymers which are particularly advantageous in the context of the invention, of diblock copolymers based on a poly(acrylic acid) hydrophilic block and on a poly(butyl acrylate) hydrophobic block and especially of poly(acrylic acid)-poly(butyl acrylate) diblock copolymers, known as PAA-PbuA diblock copolymers.

These PAA-PbuA copolymers are characterized by an (acrylic acid)/(butyl acrylate) ratio by mass which can be between 10:90 and 90:10 and this ratio is preferably between 10:90 and 50:50.

Other block copolymers which are particularly advantageous in the context of the invention are, for example, block copolymers in which the hydrophilic block (h) is a poly(acrylic acid) and the hydrophobic block (H) is a random copolymer based on styrene and on acrylic acid comprising at least 25%, preferably 50% and more preferably still 75% by weight of acrylic acid with respect to the total weight of the blend. These copolymers are characterized by an (acrylic acid block)/(styrene block) ratio by mass which can be between 95:5 and 60:40 and this ratio is preferably between 85:15 and 95:5.

The amphiphilic block copolymers used in the invention generally exhibit a number-average molecular mass of between 1 000 and 100 000. Generally, their number-average molecular mass is between 2 000 and 60 000.

Whatever its precise chemical composition, the block copolymer employed in producing the deposited layer of the invention can advantageously be prepared according to a controlled radical polymerization process carried out in the presence of a control agent.

The term “controlled radical polymerization” is to be understood as a specific radical polymerization process, also denoted by the term of “living polymerization”, in which use is made of control agent such that the polymer chains being formed are functionalized by end groups capable of being able to be reactivated in the form of free radicals by virtue of reversible transfer and/or termination reactions.

Mention may in particular be made, as examples of such polymerization processes, of:

the processes of applications WO 98/58974, WO 00/75207 and WO 01/42312, which employ a radical polymerization controlled by control agents of xanthate type,

the process for radical polymerization controlled by control agents of dithioester type of application WO 97/01478,

the process of application WO 99/03894, which employs a polymerization in the presence of nitroxide precursors,

the process for radical polymerization controlled by control agents of dithiocarbamate type of application WO 99/31144,

the process for radical polymerization controlled by control agents of dithiophosphoroesters type of application PCT/FR01/02374,

the process of application WO 96/30421, which uses atom transfer radical polymerization (ATRP),

the process for radical polymerization controlled by control agents of iniferter type according to the teaching of Otu et al., Makromol. Chem. Rapid. Commun., 3, 127 (1982),

the process for radical polymerization controlled by degenerative transfer of iodine according to the teaching of Tatemoto et al., Jap. 50, 127, 991 (1975), Daikin Kogyo Co Ltd Japan, and Matyjaszewski et al., Macromolecules, 28, 2093 (1995),

the process for radical polymerization controlled by tetraphenylethane derivatives disclosed by D. Braun et al. in Macromol. Symp., 111, 63 (1996), or

the process for radical polymerization controlled by organocobalt complexes described by Wayland et al. in J. Am. Chem. Soc., 116, 7973 (1994).

Generally, it is preferable for the block copolymers employed according to the invention to result from a controlled radical polymerization process employing, as control agent, one or more compounds selected from dithioesters, thioethers-thiones, dithiocarbamates and xanthates. In a particularly advantageous way, the block copolymers used according to the invention result from a controlled radical polymerization carried out in the presence of control agents of xanthate type.

According to a preferred embodiment, the block copolymer used can be obtained according to one of the processes of applications WO 98/58974, WO 00/75207 or WO 01/42312, which employ a radical polymerization controlled by control agents of xanthate type, it being possible for said polymerization to be carried out in particular under bulk conditions, in a solvent or, preferably, in an aqueous emulsion, so as to directly obtain the copolymer in the form of an aqueous or aqueous/alcoholic solution, or easily applicable at a content of between 0.01 and 10% by mass. A solution of the copolymer at a content of between 0.01 and 10% by weight obtained directly by a polymerization process in the same organic solvent can also be used.

Thus, it is possible to employ a process comprising the following stages:

(a) a controlled radical polymerization is carried out, resulting in the production of a functionalized polymer of use as control agent in a controlled radical polymerization reaction, said stage being carried out by bringing into contact:

ethylenically unsaturated monomer molecules,

a source of free radicals, and

at least one control agent of formula (I):

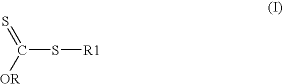

in which:

R represents:

H or Cl;

an alkyl, aryl, alkenyl or alkynyl group;

a saturated or unsaturated, optionally aromatic, carbonaceous cycle;

a saturated or unsaturated, optionally aromatic, heterocycle;

an alkylthio group,

an alkoxycarbonyl, aryloxycarbonyl, carboxyl, acyloxy or carbamoyl group;

a cyano, dialkyl- or diarylphosphonato, or dialkyl- or diarylphosphinato group;

a polymer chain,

an (R2)O— or (R2) (R′2)N— group, in which the R2 and R′2 radicals, which are identical or different, each represent:

an alkyl, acyl, aryl, alkenyl or alkynyl group;

a saturated or unsaturated, optionally aromatic, carbonaceous cycle; or

a saturated or unsaturated, optionally aromatic, heterocycle;

and

R1 represents:

an alkyl, acyl, aryl, alkenyl or alkynyl group,

a saturated or unsaturated, optionally aromatic, carbonaceous cycle;

a saturated or unsaturated, optionally aromatic, heterocycle; or

a polymer chain,

(b) following stage (a), a controlled radical polymerization stage or several successive controlled radical polymerization stages is/are carried out, said stage(s) each consisting in carrying out a controlled radical polymerization resulting in the production of a functionalized block copolymer of use as control agent in a controlled radical polymerization reaction, said stage or stages being carried out by bringing into contact:

ethylenically unsaturated monomer molecules other than those employed in the preceding stage,

a source of free radicals, and

the functionalized polymer resulting from the preceding stage.

It is understood that one of the polymerization stages (a) and (b) defined above results in the formation of the hydrophilic block (h) and that another of the polymerization stages of stages (a) and (b) results in the formation of the hydrophobic block (H). It should in particular be noted that the ethylenically unsaturated monomers employed in the stages (a) and (b) are selected from suitable monomers in order to obtain an amphiphilic block copolymer exhibiting the (h) and (H) blocks as defined above.

Thus, in the context of the formation of the hydrophobic block (H), the monomers employed can, for example, advantageously be esters of acrylic acid with linear or branched C₁-C₄ alcohols, such as, for example, methyl acrylate, ethyl acrylate, propyl acrylate or butyl acrylate, alone or as a mixture with other monomers, or else styrene as a mixture with at least 25% by weight of acrylic acid with respect to the total weight of the hydrophobic block (H).

The polymerization stages (a) and (b) are generally carried out in a solvent medium composed of water and/or of an organic solvent, such as tetrahydrofuran or a linear, cyclic or branched C₁-C₈ aliphatic alcohol, such as methanol, ethanol or cyclohexanol, or a diol, such as ethylene glycol.

An alcoholic solvent is more particularly recommended in the context of the use of hydrophilic monomers of the type of acrylic acid (AA), of acrylamide (AM), of 2-acrylamido-2-methylpropanesulfonic acid (AMPS) and of styrenesulfonate (SS) and/or in the context of the use of hydrophobic monomers, such as n-butyl acrylate, isobutyl acrylate, 2-ethylhexyl acrylate or t-butyl acrylate.

According to a final aspect, the present invention also relates to the material capable of being obtained by the process described above.

The materials obtained by the use of this process are generally such that they exhibit a strong cohesion between the surface and the coating produced.

Generally, the affinity of the coating for the low-energy surface is such that the 90° peel strength of this deposited layer at a peel rate of 300 mm/min, measurable, for example, using a dynamometer of Adamel-Lhomargy DY-30 type, is generally greater than or equal to 0.5 N/mm, advantageously greater than 1 N/mm, indeed even than 2 N/mm. In some cases, the peel strength can even be greater than 3 N/mm;

This strong affinity of the coating for the support is naturally reflected by very good stability of the coating on the surface.

In addition, the adhesion of the coating to the surface is not threatened in the presence of water.

Thus, even when the material is kept under 100% relative humidity conditions for a time of 72 hours, the 90° peel strength of the deposited layer generally remains greater than 0.5 N/mm and it is not rare for it to remain greater than 1 N/mm, indeed even than 2 N/mm, at a peel rate of 300 mm/min.

In the case of painted surfaces, the stability of the deposited layer can also be demonstrated by a test of resistance to wet abrasion, according to the DYN 53778 standard, which consists in rubbing the coating obtained with a brush of standardized hardness and standardized weight while dripping thereon water additivated with surfactant, which maintains the wetting of the surface, and in measuring the number of brushing cycle necessary to remove the coating over the whole of its thickness, so as to disclose the support.

The advantage of the use of the copolymers of the invention emerges clearly from the use of such tests, where it is found that the strength of an adhesive coating is greatly increased in the presence of these block copolymers.

The subject matter and the advantages of the present invention will become even more clearly apparent in the light of the various implementational examples set out below.

### EXAMPLE 1

### Preparation of a poly(butyl acrylate)poly(acrylic acid) diblock copolymer according to the invention, characterized by a (butyl acrylate)/poly(acrylic acid) ratio of 50:50 by weight

The following mixture is introduced into a reactor equipped with a magnetic stirrer and with a reflux column and comprising 160 g of acetone:

3.04 g of O-ethyl dithiocarbonate (denoted more simply by the term “xanthate” hereinafter),

21.24 g of isopropanol, and

0.82 g of azobisisobutyronitrile (AIBN).

The mixture was subsequently stirred and maintained at reflux at 70° C.

66 g of acrylic acid (AA) and 15 g of water were gradually added over 3 hours. 0.41 g of azobisisobutyronitrile were then added after adding for one hour and then a further 0.41 g of azobisisobutyronitrile were added after adding for a second hour.

Once the addition of acrylic acid is complete, the polymerization is allowed to continue for another hour. An amount of reaction mixture of 0.20 g is withdrawn as sample of PAA homopolymer.

The temperature is subsequently lowered to 65° C. by addition of 560 g of acetone.

140 g of butyl acrylate (BA) are added gradually over 3 hours while maintaining the temperature at 65° C. 0.40 g of AIBN is added at the beginning of the addition of BA. The reaction is allowed to continue for a further 3 hours. The reaction mixture is cooled and the solvents are virtually completely removed using a rotavapor (rotary evaporator). The residue obtained is dispersed in water and lyophilized. The polymer obtained is analyzed by carbon-13 nucleic magnetic resonance and by measuring its acid content.

The number-average molecular mass of the copolymer is 15 000.

The glass transition temperature of the hydrophobic block is −54° C.

The surface tension is 55 mN/m at 10⁻⁴ mol/l.

### EXAMPLE 2

### Preparation of a poly(butyl acrylate)poly(acrylic acid) diblock copolymer according to the invention, characterized by a (butyl acrylate)/poly(acrylic acid) ratio of 70:30 by weight

The following mixture is introduced under a nitrogen atmosphere into a reactor equipped with a magnetic stirrer and with a reflux column and comprising 160 g of acetone:

0.61 g of xanthate,

4.25 g of isopropanol,

0.16 g of azobisisobutyronitrile.

The mixture thus obtained is placed under and maintained at reflux at 70° C. 13.2 g of acrylic acid (AA) and 30.3 g of water are gradually added over 3 hours. 0.08 g of azobisisobutyronitrile are then added after adding for one hour and then a further 0.08 g of azobisisobutyronitrile are added after adding for a second hour. Once the addition of acrylic acid is complete, the polymerization is allowed to continue for another hour. An amount of reaction mixture of 4.1 g is withdrawn as sample of PAA homopolymer.

The temperature is subsequently lowered to 65° C. by addition of 112 g of acetone. 28 g of butyl acrylate (BA) are gradually added over 3 hours while maintaining the temperature at 65° C. 0.08 g of AIBN is added at the beginning of the addition of BA. The nitrogen bleed is halted and the reaction is allowed to continue for a further 12 hours. The reaction mixture is cooled and the solvents are virtually completely removed using a rotavapor (rotary evaporator). The residue obtained is dispersed in water and lyophilized. The polymer obtained is analyzed by carbon-13 nuclear magnetic resonance and by measuring the acid content.

The number-average molecular mass is 15 000.

The glass transition temperature of the hydrophobic block is −54° C.

The surface tension is 52 mN/m at 10⁻⁴ mol/l.

### EXAMPLE 3

### Preparation of a poly(styrene-co-acrylic acid)-poly(acrylic acid) diblock copolymer according to the invention, characterized by a hydrophobic block of 2K and a hydrophilic block of 14K with a variable level of acrylic acid in the hydrophobic block (in particular 73%)

### 1) Synthesis of a Random Copolymer of Styrene, of Methacrylic Acid and of Ethyl Acrylate with Ratios by Mass: St/MAA/EtA=25/2/73

The polymerization is carried out under emulsion conditions in a jacketed reactor equipped with a three-bladed stainless steel stirrer. 875 g of water, 13.9 g of sodium dodecyl sulfate (Aldrich) and 0.31 g of sodium carbonate Na₂CO₃ are introduced at ambient temperature as vessel heel. The mixture obtained is stirred for 30 minutes (190 rev/min) under nitrogen. The stirring continues for an additional period of 55 minutes, during which the temperature is raised to 75° C., and then a mixture comprising 2.16 g of styrene, 9.01 g of methyl α-(O-ethylxanthyl)propionate (CH₃CHCO₂Me)SCSOEt, 0.17 g of methacrylic acid and 6.32 g of ethyl acrylate is incorporated. The temperature is subsequently raised to 85° C. and 1.58 g of ammonium persulfate (NH₄)₂S₂O₈ are added. After five minutes, the addition of 19.49 g of styrene, 1.56 g of methacrylic acid and 56.91 g of ethyl acrylate is continued for one hour. When the addition is complete, a polymer as an emulsion (latex) is obtained and is maintained at 85° C. for one hour.

197.29 g of the copolymer as an emulsion obtained above are withdrawn. 0.79 g of ammonium persulfate (NH₄)₂S₂O₈ and 3.5 g of water are added to it at 85° C. After five minutes, the addition is begun of a mixture composed of:

661.27 g of ethyl acrylate (EtA),

13.49 g of methacrylic acid (MAA),

and simultaneously another composed of:

420 g of water,

0.75 g of Na₂CO₃.

The addition lasts 1 hour. The system is maintained at this temperature for an additional three hours.

### 2) Hydrolysis of the Diblock Copolymer

The hydrolysis is also carried out in a jacketed reactor equipped with a three-bladed stainless steel stirrer. The following are introduced therein:

54 g of the preceding copolymer (the solids content at 35.09%)

250.8 g of water (to adjust the solids content to 4%).

The temperature is brought to 85° C., during which the emulsion is vigorously stirred. 182 g of 2N sodium hydroxide (corresponding to two molar equivalents of sodium hydroxide with respect to the ethyl acrylate) are subsequently added thereto over two hours. After complete addition of the sodium hydroxide, the temperature is brought to 95° C. and the reaction is maintained under these conditions for 48 hours.

### EXAMPLE 4

### Use of poly(butyl acrylate)-poly(acrylic acid) diblock copolymers according to the invention for improving the effectiveness of the deposition of a latex on a support of thermoplastic polymer type

The poly(butyl acrylate)-poly(acrylic acid) diblock copolymers obtained in examples 1 and 2 are employed in carrying out the deposition of an adhesion primer coat on various flat supports made of thermoplastic polymers. The primer coat produced is subsequently used to carry out the deposition of a latex. By way of comparison, the deposition of the latex is also carried out on a control surface without an adhesion primer coat.

The latex used in the context of the various tests carried out in this example is an industrial acrylic latex used in particular in decorative paint, sold by Rhodia under the reference DS 1003.

It is an aqueous dispersion of particles of styrene/butyl acrylate copolymers, the mean diameter of which is 0.15 microns, characterized by a polymer content of 50% by mass.

In each of the tests carried out, the surface of the support employed was cleaned beforehand with a rag impregnated with ethanol, so as to carry out a degreasing. After cleaning, each of the supports is placed in a climate-controlled chamber at 22° C. (±3° C.) and under relative humidity conditions of 55% (±5%) for 4 hours.

The characteristics of the supports are given in table I below:

TABLE I

| | | Angle |
|---|---|---|
| | | formed by |
| | | a drop of |
| Support | Formula | water |
| Polyamide 6,6 (Nylon-PA) | (—NH—CH₂)₆—NH—CO—(CH₂)₄—CO—) | 54° |
| Polycarbonates (PC) | (—O—CO—C—R—) | 77° |
| Poly(ethylene terephthalate) | (—Ar—CO—O—(CH₂)₂—) | 79° |
| (PETP) | | |
| Poly(methyl methacrylate) (PMMA) | (—CH₂—CMe(COOCH₂)—) | 72° |
| Polypropylene (PP) | (—CH₂—CH(Me)—) | 102° |
| Polystyrene (PS) | (—CH₂—CH(Ar—)—) | 81° |
| Poly(vinyl chloride) (PVC) | (—CH₂—CHCl—) | 83° |
| ABS | Acrylonitrile-butadiene- | 74° |
| | styrene | |

With the exception of the control surfaces, a film with a uniform thickness of 50 microns of a solution of the copolymer of example 1 or of example 2 at a concentration of 1% by mass in demineralized water, to which either hydrochloric acid is added until a pH of 5 is obtained or to which sodium hydroxide is added until a pH of 8.5 is obtained, is applied, using a film drawer, to the surface of the support thus conditioned.

The film thus formed is subsequently allowed to dry for 12 hours in a climate-controlled chamber at 22° C. (±3° C.) and under relative humidity conditions of 55% (±5%), so as to produce an adhesion primer coat.

The latex is subsequently deposited on the surface, which may or may not be modified by the presence of the adhesion primer coat depending on the tests, also using 20 a film drawer, so as to produce a film of latex with a thickness of 1.5 mm, which was immediately covered with a strip of cloth with a width of 25 mm, intended to make it possible to subsequently carry out a 90° peel test on the coating obtained.

The film is subsequently allowed to dry for 12 hours in a climate-controlled chamber at 22° C. (±3° C.) and under relative humidity conditions of 55% (±5%).

An accelerated aging of the coated support thus obtained is subsequently carried out by placing it in an oven at 40° C. and at 30% relative humidity for 12 hours.

The samples are subsequently placed in a climate-controlled chamber at 22° C. (±3° C.) and under relative humidity conditions of 55% (±5%) for 12 hours.

Following these various stages, the coated support obtained is immersed for 72 consecutive hours in demineralized water.

At the end of this soaking, a 90° peel test is carried out on the coating obtained, which test consists in pulling the strip of cloth attached to the coating in a direction perpendicular to the surface of the support until detachment of the coating and of the surface is obtained, over a length of 100 mm, the forces involved being measured using an Adamel-Lhomargy dynamometer of DY-30 type with a sensor of 100 N maximum.

At the end of this test, a mean 90° tensile strength (T₉₀ ), expressed in N/mm, which reflects the affinity of the coating produced with respect to the surface of the support and the stability of this coating, is determined.

The results obtained in the various tests carried out are combined in tables II to VII hereinafter:

TABLE II
Tests on a polyamide support

| Nature of the solution employed in | |
|---|---|
| producing the adhesion primer coat | T₉₀ (in N/mm) |
| No adhesion primer coat (control) | 0.4 |
| Copolymer of example 1 in aqueous | 1.9 |
| solution at pH = 5 | |
| Copolymer of example 1 in aqueous | 4.0 |
| solution at pH = 8.5 | |
| Copolymer of example 2 in aqueous | 2.1 |
| solution at pH = 5 | |
| Copolymer of example 2 in aqueous | 1.8 |
| solution at pH = 8.5 | |

TABLE III
Tests on a polycarbonate support

| Nature of the solution employed in | |
|---|---|
| producing the adhesion primer coat | T₉₀ (in N/mm) |
| No adhesion primer coat (control) | 1.1 |
| Copolymer of example 1 in aqueous | 3.8 |
| solution at pH = 5 | |
| Copolymer of example 1 in aqueous | 3.7 |
| solution at pH = 8.5 | |
| Copolymer of example 2 in aqueous | 2.2 |
| solution at pH = 5 | |
| Copolymer of example 2 in aqueous | 2.7 |
| solution at pH = 8.5 | |

TABLE IV
Tests on a poly(ethylene terephthalate)
support

| Nature of the solution employed in | |
|---|---|
| producing the adhesion primer coat | T₉₀ (in N/mm) |
| No adhesion primer coat (control) | 1.0 |
| Copolymer of example 1 in aqueous | 2.4 |
| solution at pH = 5 | |
| Copolymer of example 1 in aqueous | 3.0 |
| solution at pH = 8.5 | |
| Copolymer of example 2 in aqueous | 3.0 |
| solution at pH = 5 | |
| Copolymer of example 2 in aqueous | 2.0 |
| solution at pH = 8.5 | |

TABLE V
Tests on a poly(methyl methacrylate) support

| Nature of the solution employed in | |
|---|---|
| producing the adhesion primer coat | T₉₀ (in N/mm) |
| No adhesion primer coat (control) | 0.6 |
| Copolymer of example 1 in aqueous | 3.3 |
| solution at pH = 5 | |
| Copolymer of example 1 in aqueous | 3.6 |
| solution at pH = 8.5 | |
| Copolymer of example 2 in aqueous | 3.0 |
| solution at pH = 5 | |
| Copolymer of example 2 in aqueous | 3.1 |
| solution at pH = 8.5 | |

TABLE VI
Tests on a polystyrene support

| Nature of the solution employed in | |
|---|---|
| producing the adhesion primer coat | T₉₀ (in N/mm) |
| No adhesion primer coat (control) | 1.5 |
| Copolymer of example 1 in aqueous | 3.3 |
| solution at pH = 5 | |
| Copolymer of example 1 in aqueous | 3.7 |
| solution at pH = 8.5 | |
| Copolymer of example 2 in aqueous | 3.0 |
| solution at pH = 5 | |
| Copolymer of example 2 in aqueous | 3.6 |
| solution at pH = 8.5 | |

TABLE VII
Tests on a poly(vinyl chloride) support

| Nature of the solution employed in | |
|---|---|
| producing the adhesion primer coat | T₉₀ (in N/mm) |
| No adhesion primer coat (control) | 1.2 |
| Copolymer of example 1 in aqueous | 2.7 |
| solution at pH = 5 | |
| Copolymer of example 1 in aqueous | 2.8 |
| solution at pH = 8.5 | |
| Copolymer of example 2 in aqueous | 2.7 |
| solution at pH = 5 | |
| Copolymer of example 2 in aqueous | 2.8 |
| solution at pH = 8.5 | |

### EXAMPLE 4

### Use of the poly(butyl acrylate)-poly(acrylic acid) diblock copolymers of the invention for improving the resistance to wet abrasion of a paint coating deposited on a thermoplastic polymer support

The diblock copolymer of example 1 was employed in carrying out the deposition of an adhesion primer coat on a flat PVC support, black in color, reference Papier Lénéta.

The surface of the support employed was cleaned beforehand with a rag impregnated with ethanol, so as to carry out a degreasing. After cleaning, the support was placed in a climate-controlled chamber at 22° C. (±3° C.) and under relative humidity conditions of 55% (±5%) for 4 hours.

A film with a uniform thickness of 50 microns of a solution of the copolymer of example 1 at a concentration of 1% by mass in demineralized water, to which sodium hydroxide is added until a pH of 8.5 is obtained, was subsequently applied, using a film drawer, to the surface of the support thus conditioned.

The film thus formed was subsequently allowed to dry in a climate-controlled chamber at 22° C. (±3° C.) and under relative humidity conditions of 55% (±5%) for 12 hours, so as to produce an adhesion primer coat.

A film with a wet thickness of 275 microns of a paint formulation (which corresponds to a dry paint film of approximately 100 microns) was subsequently deposited, using a film drawer, on the surface modified by the presence of the adhesion primer coat, this paint formulation comprising:

100 parts by weight of calcium carbonate,

10 parts by weight of DS 1003 latex as defined in example 3,

water, added so as to obtain a formulation possessing a solids content of 72% by mass.

The film obtained was subsequently allowed to dry in a climate-controlled chamber at 22° C. (±3° C.) and under relative humidity conditions of 55% (±5%) for 21 days.

Following these various stages, the coated support obtained was subjected to a test of resistance to wet abrasion (recorded as WAR) as defined in the DIN 53778 standard, which evaluates the resistance of the paint to washing and/or to detergent treatment. It consists of the cyclic abrasion of a film of paint by a brush of standardized mass and standardized hardness while dripping a soap solution thereon. The WAR is expressed as the number of abrasion cycles which can be endured by the film before seeing the support appear: 100% of the paint has been removed.

The number of wet abrasion cycles necessary to remove 100% of the coating obtained was measured to be 732.

By way of comparison, the same experiment was carried out on a PVC support coated with the paint composition, in the absence of adhesion primer coat based on the copolymer of example 1. The number of wet abrasion cycles necessary was then measured to be 582, which clearly demonstrates the improvement in the cohesion between the, support and the coating induced by the use of the block copolymer of the invention as adhesion primer coat.

### EXAMPLE 5

### Use of the poly(styrene-co-acrylic acid)poly(acrylic acid) and poly(butyl acrylate)poly(acrylic acid) diblock copolymers of the invention for improving the adhesion of silicone mastic to a thermoplastic polymer support

The poly(vinyl chloride) support was cleaned by wiping with a rag impregnated with ethanol and was then conditioned at approximately 55% relative humidity at 21° C. for 24 h.

The diblock copolymers used are the copolymers synthesized in examples 1 and 3, in addition to a diblock copolymer of the type of example 3, PS-AA-b-PAA, comprising 25% of acrylic acid in the styrene block. They are soluble in water and were deposited from 10 g/liter solutions (and solutions of pH 8.5 for the aqueous solutions), using a film drawer set at 50 μm, and then dried in a climate-controlled chamber for 24 hours.

A layer of mastic with a thickness of 1.5 mm was subsequently deposited using a film drawer, before being covered with a reinforcing film made of blue cloth, itself covered with a layer of mastic with a thickness of 1 mm. The entire assembly is dried in a climate-controlled chamber for 7 days before peeling. A commercially available mastic was tested, namely the mastic Rhodia 10 T. which is an anhydrous formulation.

The peel test was carried out by measuring the tensile strength of the mastic film along an angle of 90° with respect to the support.

The pull rate is 300 mm/min and the strength is expressed as a function of the width of the peel front; it is expressed in N/mm.

The results obtained are combined in table VIII:

TABLE VIII

| | | | | Polymer of the type of |
|---|---|---|---|---|
| | No primer | | | example 3, PS-AA-b-PAA, |
| | (mastic | Polymer of | Polymer of | comprising 25% of acrylic |
| PVC | alone) | example 1 | example 3 | acid in the styrene block |
| Rhodia 10 T | 1.6 | 1.6 | 3.0 | 2.4 |

1. Use of an amphiphilic block copolymer comprising at least one block of hydrophobic nature and at least one block of hydrophilic nature, the block of hydrophobic nature exhibiting hydrophilic units in an amount of 0% and 95% by weight with respect to the total weight of the units of the hydrophobic block, said copolymer optionally being dissolved in a solvent, such as an organic solvent, water or a water/alcohol mixture, to produce, on a low-energy surface, a deposited layer which increases the affinity of said surface with respect to water.

2. Use of an amphiphilic block copolymer comprising at least one block of hydrophobic nature (H) and at least one block of hydrophilic nature (h), the block of hydrophobic nature exhibiting hydrophilic units in an amount of 0% and 95% by weight with respect to the total weight of the units of the hydrophobic block, said copolymer optionally being dissolved in a solvent, such as an organic solvent, water or a water/alcohol mixture, to produce, on a surface possessing a hydrophobic nature, a deposited layer which renders this surface compatible with an environment possessing a hydrophilic nature.

3. The use as claimed in claim 2, characterized in that the surface possessing a hydrophobic nature is a fiber.

4. Use of an amphiphilic block copolymer comprising at least one block of hydrophobic nature (H) and at least one block of hydrophilic nature (h), the block of hydrophobic nature exhibiting hydrophilic units in an amount of between 0% and 95% by weight with respect to the total weight of the units of the hydrophobic block, said copolymer optionally being dissolved in a solvent, such as an organic solvent, water or a water/alcohol mixture, to produce, on a low-energy surface, a deposited layer which renders effective and lasting a subsequent application of a composition (F) to said low-energy surface.

5. The use as claimed in any one of the preceding claims, characterized in that the deposited layer based on said block copolymer is produced by applying, to said low-energy surface, a solution comprising this block copolymer or by immersing said low-energy surface in a solution based on the block copolymer, and by then at least partially removing the solvent initially present in this solution.

6. The use as claimed in any one of the preceding claims, characterized in that the low-energy surface is a surface exhibiting a contact angle of a drop of water deposited on the surface, corresponding to the angle which exists between the surface and the tangent to the drop at the surface/water/air interface, which is greater than 45°.

7. The use as claimed in any one of the preceding claims, characterized in that the low-energy surface is a surface based on a polyamide, on a polycarbonate, on a poly(ethylene terephthalate), on a poly(methyl methacrylate)., on a polypropylene, on a polyethylene, on a polystyrene, on a polyester, on an acrylonitrile-butadiene-styrene (ABS) or on a poly(vinyl chloride).

8. The use as claimed in any one of the preceding claims, characterized in that the block copolymer deposited layer is produced in the form of a continuous film.

9. The use as claimed in one of the preceding claims, characterized in that the block copolymer employed is such that its hydrophilic block (h) is composed, at least in part, of monomer units selected from:
unsaturated ethylenic mono- and dicarboxylic acids, such as acrylic acid, methacrylic acid, itaconic acid, maleic acid or fumaric acid,
monoalkyl esters of the above unsaturated ethylenic dicarboxylic acids, preferably with C₁-C₄ alcohols, and their N-substituted derivatives, such as, for example, 2-hydroxyethyl acrylate or methacrylate,
amides of unsaturated carboxylic acids, such as acrylamide or methacrylamide, or
ethylenic monomers comprising a ureido group, such as ethylene urea ethyl methacrylamide or ethylene urea ethyl methacrylate, or
ethylenic monomers comprising at least one hydrogen phosphate or phosphonate group, such as vinylphosphonic acid or vinylidenephosphonic acid, or
phosphated acrylates or methacrylates of polyethylene glycol or phosphated acrylates or methacrylates of polypropylene glycol, or
ethylenic monomers comprising a sulfonic acid group or one of its alkali metal or ammonium salts, such as, for example, vinylsulfonic acid, vinylbenzenesulfonic acid, α-acrylamidomethylpropanesulfonic acid or 2-sulfoethylene methacrylate, or
cationic monomers selected from aminoalkyl (meth)acrylates or aminoalkyl(meth)acrylamides; monomers comprising at least one secondary, tertiary or quaternary amine functional group or a heterocyclic group comprising a nitrogen atom, vinylamine or ethyleneimine; diallyldialkylammonium salts; these monomers being taken alone or as mixtures, and in the form of salts, the salts preferably being selected such that the counterion is a halide, such as, for example, a chloride, or a sulfate, a hydrosulfate, an alkyl sulfate (for example comprising 1 to 6 carbon atoms), a phosphate, a citrate, a formate or an acetate, such as dimethylaminoethyl (meth)acrylate, dimethylaminopropyl (meth)acrylate, di(tert-butyl)aminoethyl (meth)acrylate, dimethylaminomethyl(meth)acrylamide or dimethylaminopropyl(meth)acrylamide; ethyleneimine, vinylamine, 2-vinylpyridine or 4-vinylpyridine; trimethylammonium ethyl (meth)acrylate chloride, trimethylammonium ethyl acrylate methyl sulfate, benzyldimethylammonium ethyl (meth) acrylate chloride, 4-benzoylbenzyldimethylammonium ethyl acrylate chloride, trimethylammonium ethyl (meth)acrylamido chloride or (vinylbenzyl)trimethylammonium chloride; diallyldimethylammonium chloride, alone or as mixtures, or their corresponding salts, or
poly(vinyl alcohol), for example resulting from hydrolysis of a poly(vinyl acetate), or
cyclic amides of vinylamine, such as N-vinylpyrrolidone, or
a hydrophilic monomer originating from a chemical modification of a hydrophobic block, for example by hydrolysis of a poly(alkyl acrylate) to poly (acrylic acid).

10. The use as claimed in claim 9, characterized in that the monomer units present in the hydrophilic block (h) of the block copolymer employed are acrylic acid (AA), 2-acrylamido-2-methylpropanesulfonic acid (AMPS) or styrenesulfonate (SS) units, monomers comprising ureido group, monomers comprising phosphate or phosphonate group, or their mixtures.

11. The use as claimed in one of the preceding claims, characterized in that the block copolymer employed is such that its hydrophobic block (H) is composed, at least in part, of monomer units selected from:
styrene-derived monomers, such as styrene, α-methylstyrene, para-methylstyrene or para-(tert-butyl)styrene, or
esters of acrylic acid or of methacrylic acid with optionally fluorinated C₁-C₁₂, preferably Cₗ-C₈, alcohols, such as, for example, methyl acrylate, ethyl acrylate, propyl acrylate, n-butyl acrylate, isobutyl acrylate, 2-ethylhexyl acrylate, t-butyl acrylate, methyl methacrylate, ethyl methacrylate, n-butyl methacrylate or isobutyl methacrylate,
vinyl nitriles comprising from 3 to 12 carbon atoms and in particular acrylonitrile or methacrylonitrile,
vinyl esters of carboxylic acids, such as vinyl acetate, vinyl versatate or vinyl propionate,
vinyl halides, for example vinyl chloride, and
diene monomers, for example butadiene or isoprene.

12. The use as claimed in claim 11, characterized in that the monomer units present in the hydrophobic block (H) of the block copolymer employed are esters of acrylic acid with linear or branched C₁-C₈ and in particular C₁-C₄ alcohols, such as, for example, methyl acrylate, ethyl acrylate, propyl acrylate, butyl acrylate or 2-ethylhexyl acrylate, or else styrene derivatives, such as styrene.

13. The use as claimed in one of the preceding claims, characterized in that the block copolymer employed is a poly(acrylic acid)-poly(butyl acrylate) diblock copolymer.

14. The use as claimed in claim 13, characterized in that the (acrylic acid)/(butyl acrylate) ratio by mass is between 10:90 and 90:10.

15. The use as claimed in any one of claims 1 to 12, characterized in that the block copolymer employed is a diblock copolymer in which the hydrophilic block (h) is a poly(acrylic acid) and the hydrophobic block (H) is a random copolymer based on styrene and on acrylic acid comprising at least 25%, preferably 50% and more preferably still 75% by weight of acrylic acid with respect to the total weight of the blend.

16. The use as claimed in claim 15, characterized in that the (acrylic acid block)/(styrene block) ratio by mass is between 95:5 and 60:40.

17. The use as claimed in one of the preceding claims, characterized in that the block copolymer employed is obtained on conclusion of a controlled radical polymerization process, preferably using, as control agent, one or more compounds selected from dithioesters, thioethers-thiones, dithiocarbamates and xanthates, said polymerization being carried out in particular under bulk conditions, in a solvent or in an aqueous emulsion, so as to directly obtain the copolymer in the form of a solution in a solvent, such as an organic solvent, water or a water/alcohol mixture.

18. The use as claimed in claim 17, characterized in that the block copolymer solution has a content of between 0.01 and 10% by mass, this content being expressed with respect to the total mass of the solution.

19. The use as claimed in claim 18, characterized in that the block copolymer solution has a content of between 0.05 and 7% by mass, this content being expressed with respect to the total mass of the solution.

20. The use as claimed in either of claims 18 and 19, characterized in that the block copolymer solution has a content of between 0.1 and 3% by mass, this content being expressed with respect to the total mass of the solution.

21. The use as claimed in any one of claims 17 to 20, characterized in that block copolymer is deposited in the form of a film with a thickness of between 10 nm and 1 μm.

22. A process for the application of an aqueous film-forming composition (F) to a low-energy surface, comprising the following stages:
(A) a formulation optionally comprising a solvent, such as an organic solvent, water or an hydrophilic nature, the block of hydrophobic nature exhibiting hydrophilic units in an amount of between 0% and 95% by weight with respect to the total weight of the units of the hydrophobic block, is applied to said surface, so as to form, on said surface, a deposited layer in the form of a continuous coat; and
(B) the solvent is at least partially removed from the deposited layer obtained in stage (A); and
(C) said aqueous film-forming composition (F) is applied to the surface, thus modified, obtained in stage (B).

23. The process as claimed in any one of the preceding claims, characterized in that the low-energy surface is a surface exhibiting a contact angle of a drop of water deposited on the surface, corresponding to the angle which exists between the surface and the tangent to the drop at the surface/water/air interface, which is greater than 45°.

24. The process as claimed in either one of the preceding claims, characterized in that the low-energy surface is a surface based on a polyamide, on a polycarbonate, on a poly(ethylene terephthalate), on a poly(methyl methacrylate), on a polypropylene, on a polyethylene, on a polystyrene, on a polyester, on an acrylonitrile-butadiene-styrene (ABS) or on a poly (vinyl chloride)

25. The process as claimed in any one of the preceding claims, characterized in that the deposited layer based on said block copolymer is produced by applying, to said low-energy surface, a solution comprising this block copolymer or by immersing said low-energy surface in a solution based on the block copolymer, and by then at least partially removing the solvent initially present in this solution.

26. The process as claimed in any one of claims 22 to 25, characterized in that the aqueous formulation applied to the surface during stage (A) is a solution composed essentially of said block copolymer in water or in a water/ethanol mixture.

27. The process as claimed in one of claims 22 to 26, characterized in that the aqueous formulation applied to the surface during stage (A) comprises said block copolymer in a content of between 0.01 and 10% by mass, this content being expressed with respect to the total mass of the formulation.

28. The process as claimed in claim 27, characterized in that the aqueous formulation applied to the surface during stage (A) comprises said block copolymer in a content of between 0.05 and 7% by mass, this content being expressed with respect to the total mass of the formulation.

29. The process as claimed in claim 27 or 28, characterized in that the aqueous formulation applied to the surface during stage (A) comprises said block copolymer in a content of between 0.1 and 3% by mass, this content being expressed with respect to the total mass of the formulation.

30. The process as claimed in any one of claims 22 to 29, characterized in that the block copolymer deposited layer in the form of a continuous coat obtained in stage B has a thickness of between 10 nm and 1 μm.

31. The process as claimed in claim 30, characterized in that the block copolymer deposited layer in the form of a continuous coat obtained in stage B has a thickness of:between 40 nm and 600 nm.

32. The process as claimed in claim 30 or 31, characterized in that the block copolymer deposited layer in the form of a continuous coat obtained in stage B has a thickness of between 50 nm and 500 nm.

33. The process as claimed in one of the preceding claims, characterized in that the block copolymer employed is as defined in one of claims 9 to 16.

34. The process as claimed in one of the preceding claims, characterized in that the block copolymer employed is obtained on conclusion of a controlled radical polymerization process, preferably using, as control agent, one or more compounds selected from dithioesters, thioethers-thiones, dithiocarbamates and xanthates, said polymerization being carried out in an aqueous emulsion, so as to directly obtain the copolymer in the form of an aqueous or aqueous/alcoholic solution.

35. The process as claimed in one of claims 22 to 34, characterized in that the composition (F) is an aqueous dispersion of at least one polymer.

36. The process as claimed in claim 35, characterized in that, in stage (B), the aqueous composition (F) is applied in the form of a continuous film to the deposited layer based on the block copolymer.

37. The process as claimed in one of claims 22 to 36, characterized in that, following the application of said composition (F) of stage (C), the surface covered with said composition (F) is subjected to a stage (D) of removal of the solvent phase present in the composition applied.

38. The process as claimed in one of claims 22 to 37, characterized in that the composition (F) is an adhesive composition, a paint composition or a mastic composition, which may or may not comprise silicone.

39. A material comprising a low-energy surface capable of being obtained according to the process of any one of claims 22 to 38.
